(19) United States
(12) Patent Application Publication
(10) Pub. No.: US 2009/0152351 A1
(43) Pub. Date: Jun. 18, 2009

(54) Detecting An Encoder Material Reading Error

(76) Inventors: Michael Nordlund, Singapore (SG); Chee Wah See Toh, Singapore (SG); Pock Chueng Teo, Singapore (SG); Chew Say Eng, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/197,315

(22) Filed: Aug. 25, 2008

Related U.S. Application Data
(60) Provisional application No. 61/013,698, filed on Dec. 14, 2007.

(51) Int. Cl. G06K 5/00

(52) U.S. Cl. 235/437

(57) ABSTRACT

In a method for detecting an encoder material reading error, at least one of a sensor and an encoder material is slewed with respect to each other. Markers on the encoder material are detected with the sensor as at least one of the sensor and the encoder material is slewed with respect to each other to obtain position vs. time data of the sensor with respect to the encoder material. The position vs. time data is analyzed to determine whether a speed at which at least one of the sensor and the encoder material travels with respect to each other fell below a predetermined threshold. In addition, a determination that an encoder material reading error has occurred is made in response to a determination that the speed fell below the predetermined threshold.

This application claims the benefit of provisional patent application Ser. No. 61/013698, filed 14 Dec. 2007, titled “Detecting An Encoder Material Reading Error,” which application is incorporated by reference herein as if reproduced in full below.

### BACKGROUND

Many imaging systems, such as, scanning, printing, and multifunction devices, operate by slewing a carriage across the width of a document. Scanning devices typically include an optical reader positioned on the carriage, which scans the document as the carriage is slewed across the document. Printing devices typically include printheads positioned on the carriage, which are implemented to fire ink in droplets as the carriage is slewed over the document. Multifunction devices typically include a combination of an optical reader and printheads positioned on one or more carriages.

In these types of devices, the carriage position is often tracked through use of an optical sensor positioned on the carriage and an encoder strip. Typically, the encoder strip extends across a scanning or printing width of an imaging system and has black lines printed at fixed intervals along its length. As the carriage slews across a document, the optical sensor reads the lines in the encoder strip and the position of the carriage is determined based upon the number of lines that have been read.

There are several problems associated with the use of encoder strips to determine the position of a carriage. For example, the lines on the encoder strip are prone to wear off, thus making it relatively impossible for the optical sensor to detect the lines. Moreover, ink, aerosol, and other debris are prone to contaminate and obscure the lines. As a result, the position of the carriage cannot always accurately be tracked, and, consequently, the ink droplets fired from printing devices are often deposited at incorrect locations and print quality is reduced. Similarly, documents are often incorrectly scanned.

One solution is to replace the encoder strip after a predetermined amount of time has elapsed, regardless of the amount of wear on the encoder strip. This solution requires that a calibration process also be performed after each encoder strip replacement operation. As such, this solution is time-consuming and typically requires that a relatively skilled person perform the encoder strip replacement and calibration.

It would therefore be beneficial to be able to accurately track the position of the carriage in a simple and efficient manner, regardless of the level of wear on the encoder strip.

### BRIEF DESCRIPTION OF THE DRAWINGS

Features of the present invention will become apparent to those skilled in the art from the following description with reference to the figures, in which:

FIG. 1 illustrates an imaging system configured to implement the systems and methods disclosed herein, according to an embodiment;

FIG. 2 illustrates a graph showing position vs. time data related to the slew of a carriage, according to an embodiment;

FIG. 3A illustrates a graph showing speed vs. time data related to a slew of a carriage, according to an embodiment;

FIG. 3B illustrates a graph showing the speed vs. time data related to the slew of the carriage with a predetermined threshold, according to an embodiment;

FIG. 4 illustrates a simplified system diagram of an imaging device configured to implement various embodiments disclosed herein, according to an embodiment; and

FIG. 5 illustrates a flow chart of a method for detecting an encoder material reading error, according to an embodiment.

### DETAILED DESCRIPTION

For simplicity and illustrative purposes, the present invention is described by referring mainly to embodiments. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

Disclosed herein are systems and methods for detecting an encoder material reading error and for determining the location of an encoder material reading error. The term “encoder material” refers to a component having a series of markers disposed at known intervals, which may be used in a location tracking system. For example, encoder materials may be used as part of a system for accurately tracking the location of a carriage in an imaging system. In one example, the encoder material may be placed as a strip along a scanning width of the carriage in the imaging system. In another example, the encoder material may be placed around a circular disk, which may be used in various location tracking systems, such as, paper advance location tracking systems, commonly found in inkjet printers. The imaging system may be a system for reading data, such as a scanning device, a system for depositing indicia, such as a printing device, or a multifunction machine.

Another component of the system for determining the location of the carriage is a sensor positioned in such a way as to detect the markers on the encoder material. The sensor obtains data during the relative movement between the sensor and the marked encoder material. The resulting data is processed to determine, for instance, the position of a carriage, and thus, the printhead and/or optical reader positioned on the carriage, with respect to the printable media. In addition, or alternatively, the data may be processed to determine the position of a print medial with respect to an imaging system. Generally, for this case, an optical reader is in a fixed position and a circular disk encoder is rotated in conjunction with al media drive roller mechanism. This configuration is used to determine the media position with respect to the printhead.

As mentioned above, when the sensor is unable to read one or more of the markers on the encoder material, determining the exact relative movement between the sensor and the encoder material becomes relatively difficult. This is because the sensor typically “counts” the markers sequentially as the sensor moves with respect to the encoder material or as the encoder material moves with respect to the sensor during a carriage movement, or “slew”, along the sensor. When the sensor is unable to read a marker, the sensor misses a “count” and, as a result, the carriage position may be inaccurately determined.

The systems and methods described herein allow for the detection of an encoder material reading error, such as a missed count, by acquiring position vs. time data related to the movement of either of the sensor and the encoder material with respect to each other, such as when a carriage is moved with respect to an imaging system. Position vs. time data refers to the location of, for instance, the carriage with respect to the imaging system at various points in time. By way of example, the distances within a ¼ inch of the carriage slew over a number of milliseconds may be determined. It should, however, be understood that specific measurements and the units used to quantify the measurements are described herein merely as illustrative examples and that any reasonably suitable measurements and units of measurement may be used.

According to an embodiment, the position vs. time data is converted into speed vs. time data. Speed vs. time data includes various speeds at which the carriage travels at various points in time. This data may be analyzed to determine if a sudden drop in speed occurred during the carriage slew. By way of example, a sudden drop in speed may be defined as a drop in speed that falls below a predetermined threshold speed, which may be set based upon the average speed of the carriage movement. In some examples, a sudden drop in speed may refer to a drop of about 50% or more from the average speed.

A sudden drop in the speed may be correlated to a missed count, because the carriage speed data will show an abrupt slowdown when a marker on the encoder material cannot be read. However, once past the unreadable marker, the carriage speed will show a quick return back to its average speed for the remainder of the slew. Therefore, any sudden drop in the derived speed data may indicate that an encoder material reader error occurred during the sudden drop in speed.

After a determination has been made that an encoder material reading error has occurred, the speed vs. time data may be converted back into position vs. time data to determine the location of the encoder material reading error. As disclosed in greater detail herein below, the imaging system may compensate for the encoder material reading error at the determined location.

The systems and methods described herein may be implemented without requiring any new hardware to be installed into imaging systems. Hence, implementation of the systems and methods disclosed herein require little to no additional cost to imaging systems. The systems and methods described herein also provide sufficient resolution such that even a single lost count may be detected.

According to an example, the systems and methods disclosed herein may be integrated directly into an imaging system, such that the imaging system will monitor itself for encoder material reading errors. Alternatively, or in addition thereto, the systems and methods disclosed herein may also be decoupled from the imaging system and initiated as a command by a separate device, such as through a diagnostic test, or as a user initiated command.

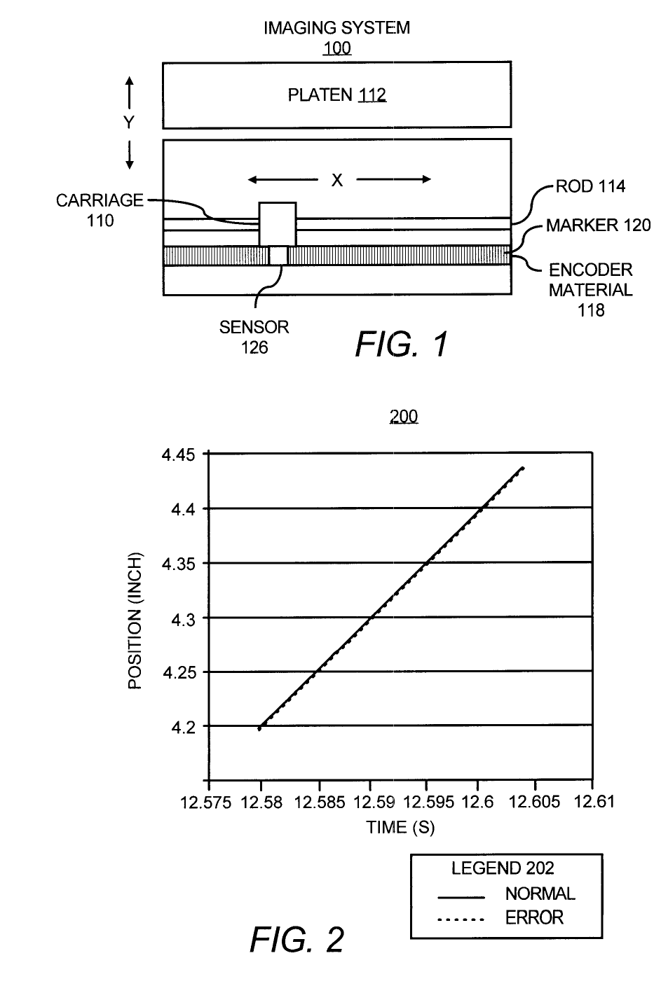

With reference first to FIG. 1, there is shown an imaging system 100 configured to implement the systems and methods disclosed herein, according to an embodiment. It should be understood that the following description of the imaging system 100 is but one manner of a variety of different manners in which such an imaging system 100 may be configured. In addition, it should be understood that the imaging system 100 may include additional elements and devices not shown in FIG. 1 and that some of the features described herein may be removed and/or modified without departing from a scope of the imaging system 100.

The imaging system 100 illustrated in FIG. 1 is a printing device for depositing printing indicia onto a printing medium. However, many of the features disclosed with respect to the printing device depicted in FIG. 1 are also applicable to a scanning device, or a multifunction machine, such as, a machine configured to perform both scanning and printing functions. As such, the imaging system 100 will be described respect to printing devices, scanning devices, and multifunction machines.

The imaging system 100 includes a carriage 110 on which an optical reader (not shown) and/or a printhead (not shown) is positioned. The carriage 110 is slewed back and forth across the imaging system 100 in a main scanning direction X across an imaging zone. The imaging zone may comprise the distance that the carriage 110 is configured to travel to either scan data from or print indicia onto a document or print medium. In the example shown in FIG. 1, a platen 112 transports a document and/or a printing medium (not shown) in a sub-scanning direction Y normal to the main scanning direction X. The carriage 110 is carried along a rod 114 which is mounted in a fixed position in relation to the platen 112 and a frame body 116. An encoder material 118 having a plurality of position markers 120 is attached to the frame body 116 and extends along the length of the distance traversed by the carriage 110.

According to another example, the document or printing medium may be maintained at a substantially fixed position and the frame body 116 may be moved in a transverse direction with respect to the X direction, as is typical with scanning devices.

In either example, a sensor 126 is fixedly mounted on the carriage 110. The sensor 126 may comprise any reasonably suitable device for reading the markers 120 on the encoder material 118, such as, an optical sensor. Thus, when the carriage 110 slews in the main scanning direction X, the markers 120 may be detected and counted by the sensor 126 (and software configured to count the markers detected by the sensor 126). In this manner, the position of the carriage 110 at any given time (position vs. time) as it travels in the main scanning direction X may be determined with a substantially high degree of accuracy by counting the markers 120.

The position vs. time data may be obtained during each pass the carriage 110 makes over the document or printing medium. Similarly, the position vs. time data may be obtained as a result of the normal operation of the imaging system 100 or as a result of a separate command. In addition, the position vs. time data may be obtained using any reasonably suitable diagnostic software and/or firmware.

However, when one or more of the markers 120 is worn off or otherwise obscured, the sensor 126 is unable to read that particular marker(s) 120 and loses one or more counts, resulting in a inaccurate determination of the carriage 110 position, as discussed above.

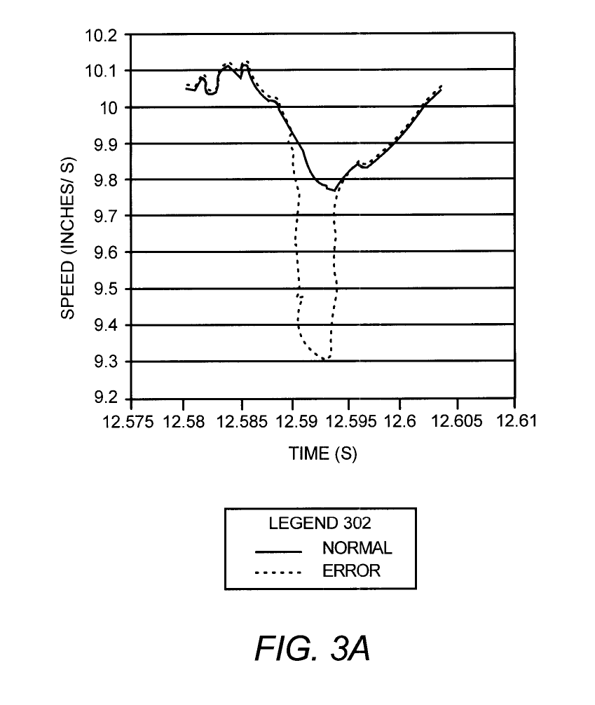

With reference now to FIG. 2, there is shown a graph 200 of an example of position vs. time data related to a slew of a carriage 110. It should be understood that the following description of the graph 200 is but one manner of a variety of different manners in which such a graph 200 may be formed. In addition, the actual rendering of the graph 200 may be unnecessary to practice the embodiments described herein. For example, if the systems and methods described herein are at least partially automated using computer systems, software, firmware, etc., then a visual representation of the position vs. time data, such as the graph 200, is not required to analyze the position vs. time data.

The position vs. time data may be obtained during a carriage 110 slew across a width of the imaging system 100. As shown in FIG. 2, the position data is represented along the Y coordinate axis and the time data is represented along the X coordinate axis. The position data is quantified in units of inches while the time data is quantified in units of seconds for purposes of illustration, but any units of measurement may be used. Also for purposes of illustration, the position data is depicted from approximately 4.15 to approximately 4.45 inches and the time data is depicted from approximately 12.575 to approximately 12.61 seconds

As the legend 202 indicates, the solid line in the graph 200 represents a “normal” slew or a slew substantially free from encoder material reading errors. However, the broken or dashed line represents a slew in which an “error” has occurred, such as an encoder material reading error. For instance, the dashed line on the graph 200 may represent a slew in which the sensor 126 is unable to read one or more of the markers 120 on the encoder material 118. Therefore, the sensor 126 has missed one or more counts and the resulting carriage 110 position determination may be inaccurate.

As the graph 200 illustrates, the difference between a normal slew and a slew containing an error is negligible when observing the position vs. time data. That is, it is difficult to determine if an error occurred during the slew of the carriage 110 by analyzing the position vs. time data.

According to an example, the position vs. time data is converted into speed vs. time data to obtain a more meaningful determination of whether an encoder material reading error has occurred. For the position data, the encoder material 118, and hence the carriage 110, is referenced by the counts from the markers 120 which can be numbered 1 to N along the slew. To perform the conversion to speed vs. time, a moving k-point average may be used to filter out noise, wherein k is any positive odd integer. The value k is used to denote which and how many data points surrounding the current position, N, and the time at the current position N, is used in the averaging. Generally, if the position and time data is analyzed sequentially on a per slew sweep basis, then data points before and after the current position and time may be used for averaging. It may be noted that as k is increased, the sensitivity of detecting encoder material reading errors is decreased because a relatively minor number of encoder material reading errors may not substantially affect the average slew speed, as the carriage 110 nearly reaches its normal speed quickly after an encoder material reading error. For this case, the average speed equation of any point N along the print sweep may be written as:

$${AverageSpeed}_{N} = \frac{\frac{{\sum }_{m = 0}^{2 k - 1} ( {Position}_{N + k - m } - {Position}_{N + k - m - 1} )}{( {Time}_{N + k - m} - {Time}_{N + k - m - 1} )}}{2 k} .$$

Position and time data analysis can also occur in real time during the print sweep if required. In this case, the average speed equation at any marker point N along the print sweep would be limited to make reference to N data points that have already be tracked. For example, for a k-point average, only (N−1) down to (N−k) data points may be referenced, thus revising the previous equation to the following:

$${AverageSpeed}_{N} = \frac{\frac{{\sum }_{m = k}^{2 k - 1} ( {Position}_{N + k - m } - {Position}_{N + k - m - 1} )}{( {Time}_{N + k - m} - {Time}_{N + k - m - 1} )}}{2 k} .$$

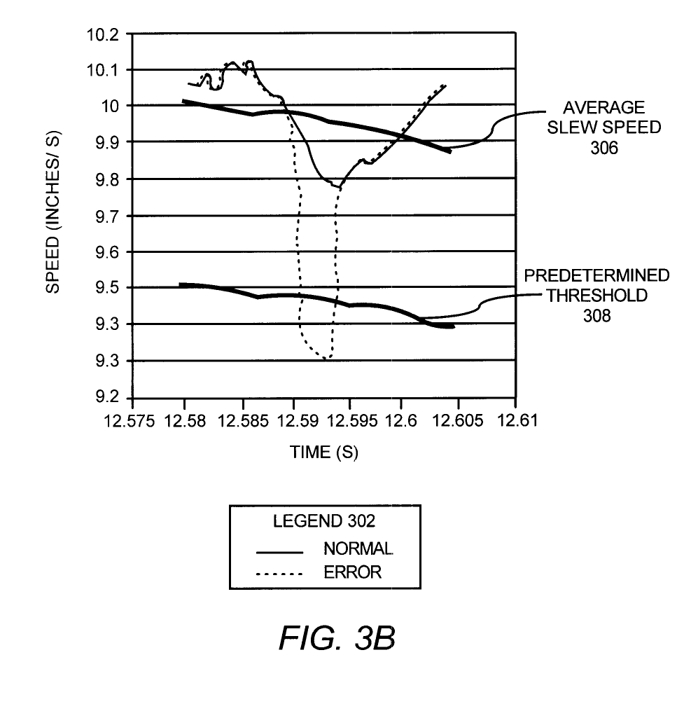

Turning now to FIG. 3A, there is shown a graph 300 of speed vs. time data derived from the position vs. time data depicted in the graph 200, according to an example. It should be understood that the following description of the graph 300 is but one manner of a variety of different manners in which such a graph 300 may be formed. In addition, the actual rendering of the graph 300 may be unnecessary to practice the embodiments described herein. For example, if the systems and methods described herein are at least partially automated using computer systems, software, firmware, etc. then creating a visual representation of the speed vs. time data, such as the graph 300, is not required to analyze the speed vs. time data.

The speed vs. time data of the graph 300 is obtained from the position vs. time data shown in FIG. 2. As shown in FIG. 3A, the speed data is represented along the Y coordinate axis and the time data is represented along the X coordinate axis. The speed data is quantified in units of inches per second while the time data is quantified in units of seconds for purpose of illustration. It should, however, be understood that the speed and time data may be quantified using any equivalent units of measurement.

As the legend 302 indicates, the solid line in the graph 300 represents the “normal” slew of the carriage, or a slew substantially free from encoder material reading errors. However, the broken or dashed line represents the slew in which an “error” has occurred, such as an encoder material reading error, as discussed above with respect to FIG. 2. The difference between a normal slew and a slew containing an encoder material reading error is more easily observed when considering the speed vs. time data. That is, from analyzing the speed vs. time data, it is clear that the solid and dashed lines diverge significantly between approximately 12.59 seconds and approximately 12.595 seconds, because the broken line exhibits a sudden drop in speed during this time period. This sudden drop in speed may be indicative of an encoder material reading error. This is because the speed of the carriage 110 may abruptly become reduced if the sensor 126 is unable read one or more of the markers 120, but then abruptly become increased shortly thereafter as shown in the graph 300.

With respect now to FIG. 3B, there is shown a graph 300′ of the speed vs. time data, which includes the speed vs. time data shown in the graph 300 of FIG. 3A. The graph 300′ additionally depicts an average slew speed 306 and a predetermined threshold 308. The average slew speed 306 depicts the average slew speed of the carriage 110 without an encoder material reading error. That is, the average slew speed 306 may represent the average slew speed of the carriage 110 when the sensor 126 reads all of the markers 120 without missing a count. For example, the average slew speed 306 may be determined by the manufacturer of the imaging system 100 while the imaging system 100 is in a substantially new condition. The average slew speed 306 may alternatively be determined at any point in the life of the imaging system 100.

The moving average slew speed 306 may be determined even as encoder material reading errors occur during the slew. This is because if the number of test points of position and time used for the moving average is sufficiently low, even a relatively minor number of encoder material reading errors can substantially affect the average slew speed 306, as the carriage 110 nearly reaches its normal speed quickly after an encoder material reading error.

The predetermined threshold speed 308 may be a percentage of the average slew speed 306 and may serve as a threshold for identifying when a sudden drop in slew speed has occurred. Therefore, a sudden drop in carriage speed below the predetermined threshold speed 308 may be defined as an indication of an encoder material reading error. Thus, the region of the graph 300′ where the broken line drops below the threshold speed 308 is deemed to be a problematic region where an encoder material reading error has occurred.

In another embodiment, an encoder material reading error may be determined by analyzing the speed vs. time data for periods of negative acceleration. This is because a dip in speed will cause acceleration to be negative and then positive. Therefore, determining when acceleration is negative and then positive will provide an indication of an encoder material reading error.

When an encoder material reading error is determined to have occurred, the speed vs. time data at the time corresponding to the time at which the encoder material reading error was determined to have occurred may be converted back into position data to determine the approximate physical location of the encoder material reading error. In addition, or alternatively, the position of the carriage 110 with respect to the encoder material 118 when the encoder material reading error was determined to have occurred may be determined. In addition, the imaging system 100 may compensate for the encoder material reading error at the location of the identified encoder material reading error.

By way of example, a timer may be started (for instance, through firmware) immediately before entering the problem region where an encoder material reading error exists. The sensor 126 may be prevented from reading the markers 120 of the encoder material 118 in the problem region. To compensate for failing to read one or more of the markers 120 on the encoder material 118, the position count may be injected into a system based on timer information and/or the number of markers 120 in the problem region which were not read by the sensor 126. Once the carriage 110 and sensor 126 have moved out of the problem region, the usual process of scanning the encoder material 118 may continue.

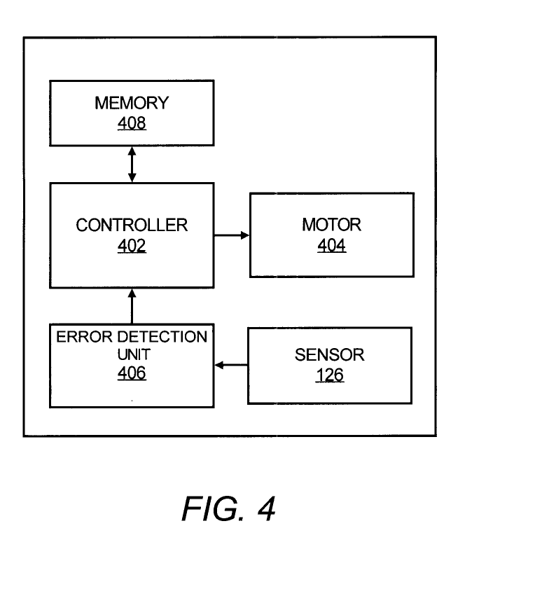

With reference now to FIG. 4, there is shown a simplified block 400 diagram of the imaging system 100 configured to implement various embodiments disclosed herein, according to an example. It should be understood that the following description of the imaging system 400 is but one manner of a variety of different manners in which such an imaging system 400 may be configured. In addition, it should be understood that the imaging system 400 may include additional elements and devices not shown in FIG. 4 and that some of the features shown therein may be removed and/or modified without departing from a scope of the imaging system 400.

The imaging system 400 includes a controller 402 for controlling various functions of the imaging system 100. The controller 402 may comprise a microprocessor, a micro-controller, an application specific integrated circuit (ASIC), and the like, configured to perform the functions discussed herein. For example, the controller 402 sends control signals to a motor 404, which moves the carriage 110 across the imaging system 100. The controller 402 also receives signals from an error detection unit 406, which receives signals from the sensor 126.

The error detection unit 406 may comprise hardware, firmware, software, or any combination of hardware, firmware, and software. For example, the error detection unit 406 may comprise a program executed by a scanner and/or printer to monitor for encoder material reading errors. In other examples, the error detection unit 406 may be part of a computing system, which communicates with a scanner and/or printer via a wired or wireless connection. The error detection unit 406 may acquire position vs. time data, convert the position vs. time data into speed vs. time data, and analyze this data to determine if a sudden drop in carriage speed as occurred. The error detection unit 406 may further determine that an encoder material reading error has occurred and may also determine the approximate location of the encoder material reading error. The controller 402 may receive information from the error detection unit 406 and may adjust the operation of the motor 404 to compensate for detected encoder material reading errors.

The controller 402 may also interface with a memory 408, which may be any reasonably suitable volatile or non-volatile memory storage. Data received and/or processed by the error detection unit 406 may be stored in the memory 408. For example, the memory 408 may store position, time, and speed data, as well as determined encoder material reading errors.

While the components illustrated in FIG. 4 are shown as an integrated part of the imaging system 100, one or more of the components shown in FIG. 4 may be part of a separate and independent device without departing from a scope of the image system 100. For example, the error detection unit 406 may be a component of a separate computing device (not shown), which interacts with the imaging system 100, either through a wired or wireless connection, to detect and locate encoder material reading errors. Thus, for instance, a computing apparatus connected to the imaging system 100 may be configured to detect and locate the encoder material reading errors.

In addition, while the imaging system 100 has been described as including an sensor 126 configured to detect the movement of a carriage 110 with respect to the imaging system 100, it should be understood that various aspects of the features disclosed herein may be applied to detecting the movement of other components in other types of systems. For instance, the encoder material 118 may be provided on a circular disk and the sensor 126 may be positioned to detect relative movement between the circular disk and the sensor 126. By way of example, the circular disk may be configured to rotate in conjunction with a media drive roller mechanism while the sensor 126 remains stationary.

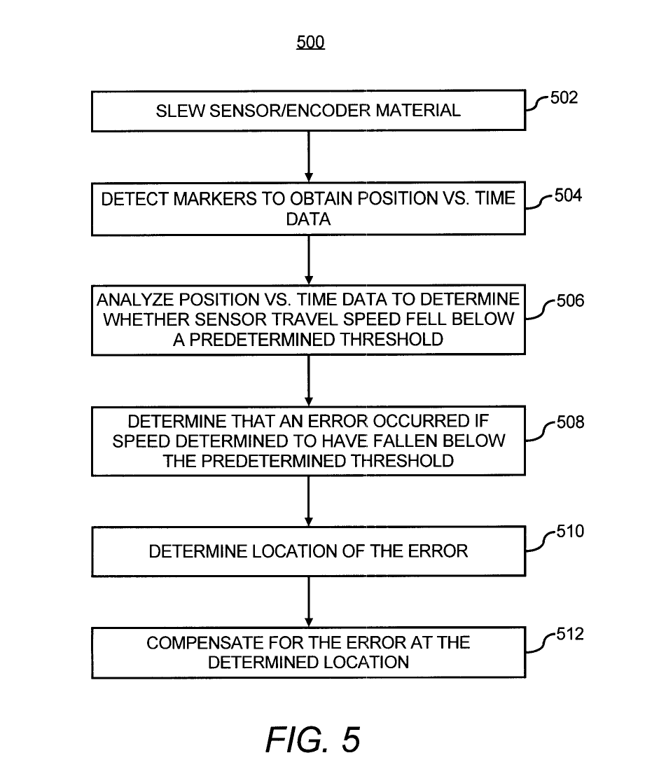

Turning now to FIG. 5, there is shown a flow diagram of a method 500 for detecting an encoder material reading error in an imaging system 100, according to an example. It is to be understood that the following description of the method 500 is but one manner of a variety of different manners in which an example of the invention may be practiced. It should also be apparent to those of ordinary skill in the art that the method 500 represents a generalized illustration and that other steps may be added or existing steps may be removed, modified or rearranged without departing from a scope of the method 500. FIG. 5 is described below with respect to the imaging system 100 of FIGS. 1 and 4 by way of example, it should, however, be understood that the method 500 may be practiced in systems and devices other than the imaging system 100.

Once the method 500 is initiated, the sensor 126/encoder material 118 is slewed with respect to each other, at step 502. More particularly, the sensor 126 is slewed with respect to the encoder material 118, the encoder material 118 is moved with respect to the sensor 126, or both the encoder material 118 and the sensor 126 are slewed with respect to each other. As described above, the sensor 126 may be attached to a carriage 110, and the carriage 110 may be slewed to move over the encoder material 118 through operation of a motor 404. As also described above, the encoder material 118 may be provided on a circular disk that is rotated with respect to the sensor 126.

As the sensor 126/encoder material 118 is slewed with respect to each other, the sensor 126 detects the markers 120 on the encoder material 118, as indicated at step 504. More particularly, for instance, the detected markers 120 are counted to determine the distance the sensor 126 has traveled with respect to the encoder material 118, or vice versa. The position of the sensor 126 respect to the encoder material 118 during the time that the sensor 126 moves with respect to the encoder material 118, or vice versa (the position vs. time data) is obtained from the correlations between the time elapsed and the number of markers 120 detected.

At step 506, the position vs. time data is analyzed to determine whether a speed at which the sensor 126 or encoder material 118 travels fell below a predetermined threshold. As described above, in determining whether the sensor 126/encoder material 118 travel speed fell below the predetermined threshold, speed vs. time data may be determined by converting the position vs. time data. In any regard, this determination may be made for the speeds at which the sensor 126/encoder material 118 traveled for the entire length of a slew operation or for a portion thereof. An example of how this determination may be made is described above with respect to FIG. 3B.

At step 508, a determination may be made that an encoder material reading error has occurred if the speed of the sensor 126/encoder material 118 travel fell below the predetermined threshold. In addition, at step 510, the location of the encoder material reading error may be determined. According to an example, the location of the sensor 126 with respect to the encoder material 118 when the error occurred may be determined by converting the speed vs. time data into position vs. time data and identifying the error location.

At step 512, the controller 402 may compensate for the encoder material reading error at the determined location of the error. According to an example, the controller 402 may compensate for the error during future slewing operations by artificially inserting one or more counts when the sensor 126 passes through the determined location of the error, as described above. In this regard, the position of the sensor 126 with respect to the encoder material 118 may more accurately be tracked when there is an encoder material reading error.

One or more of the steps described herein are operable to be implemented as software or firmware stored on a computer readable medium, such as the memory 408, and executed by a processor.

The steps contained in the method 500 are operable to be embodied by a computer program, which can exist in a variety of forms both active and inactive. For example, they exist as software and/or firmware program(s) comprised of program instructions in source code, object code, executable code or other formats for performing some of the steps. The codes described above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

What has been described and illustrated herein are examples of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims and their equivalents in which all terms are meant in their broadest reasonable sense unless otherwise indicated.

What is claimed is:

1. A method for detecting an encoder material reading error, said method comprising:
slewing at least one of a sensor and an encoder material with respect to each other, wherein the encoder material has markers positioned at substantially fixed intervals;
detecting the markers with the sensor as at least one of the sensor and the encoder material is slewed with respect to each other to obtain position vs. time data of the sensor with respect to the encoder material;
analyzing the position vs. time data to determine whether a speed at which at least one of the sensor and the encoder material travels with respect to each other fell below a predetermined threshold; and
determining that an encoder material reading error occurred in response to a determination that the speed fell below the predetermined threshold.

2. The method according to claim 1, further comprising:
determining a location of the sensor with respect to the encoder material where the speed of at least one of the sensor and the encoder material was determined to have fallen below the predetermined threshold, said location corresponding to the location of the encoder material reading error.

3. The method according to claim 2, further comprising:
compensating for the encoder material reading error at the determined location during future slewing operations of at least one of the sensor and the encoder material.

4. The method according to claim 3, wherein compensating for the encoder material reading error further comprises artificially inserting one or more counts as the sensor passes through the determined location of the encoder material reading error on the encoder material or as the determined location of the encoder material passes by the sensor.

5. The method according to claim 1, wherein analyzing the position vs. time data further comprises converting the position vs. time data into speed vs. time data.

6. The method according to claim 5, further comprising:
calculating an average speed that at least one of the sensor and the encoder material travels for a predetermined duration of time, wherein the predetermined threshold comprises a speed value that is a predetermined percentage of the calculated average speed.

7. The method according to claim 6, wherein analyzing the position vs. time data further comprises determining whether the speed at which at least one of the sensor and the encoder material travels fell below the predetermined threshold for a relatively short period of time and returned to about the average speed, and wherein determining that an encoder material reading error occurred comprises determining that an encoder material reading error occurred in response to a determination that the speed fell below the predetermined threshold for the relatively short period of time.

8. The method according to claim 5, wherein the speed that at least one of the sensor and the encoder material travels drops when a count is missed and wherein the method further comprises setting the predetermined threshold to identify the drop in speed from the calculated average speed.

9. The method according to claim 8, wherein the predetermined threshold comprises more than about 50%, of the calculated average speed.

10. A system for detecting an encoder material reading error, said system comprising:
a sensor;
an encoder material having a plurality of markers positioned at substantially fixed intervals along the encoder material, wherein the sensor is positioned to read the markers on the encoder material to determine the position of the sensor as at least one of the sensor and the encoder material is slewed with respect to each other;
a motor configured to slew at least one of the sensor and the encoder material with respect to each other; and
a controller configured to control the motor and to analyze the markers read by the sensor to obtain position vs. time data of the sensor with respect to the encoder material, to determine whether a speed at which at least one of the sensor and the encoder material travels fell below a predetermined threshold, and to determine that an encoder material reading error has occurred in response to a determination that the speed fell below the predetermined threshold.

11. The imaging system of claim 10, wherein the controller is further configured to determine a location of the sensor with respect to the encoder material wherein the speed of at least one of the sensor and the encoder material was determined to have fallen below the predetermined threshold.

12. The imaging system of claim 11, wherein the controller is further configured to compensate for the encoder material reading error at the determined location during future slewing operations.

13. The imaging system of claim 12, wherein the controller is further configured to compensate for the encoder material reading error by artificially inserting one or more counts as the sensor passes through the determined location of the encoder material reading error on the encoder material or as the determined location of the encoder material passes by the sensor.

14. The imaging system of claim 12, wherein the motor is configured to reduce the speed at which at least one of the sensor and the encoder material travels when a marker is missed, and wherein the controller is further configured to compensate for the encoder material reading error by substantially maintaining the speed of at least one of the sensor and the encoder material travel at around an average speed as the sensor travels over the determined location of the encoder material reading error or as the determined location of the encoder material reading error passes by the sensor.

15. The imaging system of claim 10, wherein the controller is further configured to convert the position vs. time data into speed vs. time data and to calculate an average speed that at least one of the sensor and the encoder material travels for a predetermined duration of time, wherein the predetermined threshold comprises a speed value that is a predetermined percentage of the calculated average speed.

16. The imaging system of claim 15, wherein the controller is further configured to determine whether the speed at which at least one of the sensor and the encoder material travels fell below the predetermined threshold for a relatively short period of time and returned to about the average speed, and to determine that an encoder material reading error occurred in response to a determination that the speed fell below the predetermined threshold for the relatively short period of time.

17. The imaging system of claim 15, wherein the controller is further configured to control the motor to substantially reduce the speed at which at least one of the sensor and the encoder material is slewed when a count is missed, and wherein the predetermined threshold is set to enable the controller to identify the drop in speed from the calculated average speed.

18. A computer readable storage medium on which is embedded one or more computer programs, said one or more computer programs implementing a method of detecting an encoder material reading error, said set of instructions comprising:
slewing at least one of a sensor and an encoder material with respect to each other, wherein the encoder material has markers positioned at substantially fixed intervals;
detecting the markers with the sensor as at least one of the sensor and the encoder material is slewed with respect to each other to obtain position vs. time data of the sensor with respect to the encoder material;
analyzing the position vs. time data to determine whether a speed at which at least one of the sensor and the encoder material travels with respect to each other fell below a predetermined threshold; and
determining that an encoder material reading error occurred in response to a determination that the speed fell below the predetermined threshold.

19. The computer readable medium according to claim 18, said one or more computer programs further comprising a set of instructions for:
determining a location of the sensor with respect to the encoder material where the speed of at least one of the sensor and the encoder material was determined to have fallen below the predetermined threshold, said location corresponding to the location of the encoder material reading error; and
compensating for the encoder material reading error at the determined location during future slewing operations of at least one of the sensor and the encoder material.

20. The computer readable medium according to claim 17, said one or more computer programs further comprising a set of instructions for:
calculating an average speed that at least one of the sensor and the encoder material travels for a predetermined duration of time, wherein the predetermined threshold comprises a speed value that is a predetermined percentage of the calculated average speed; and
setting the predetermined threshold to identify a drop in speed from the calculated average speed.
